(19) United States
(12) Patent Application Publication
(10) Pub. No.: US 2002/0166737 A1
(43) Pub. Date: Nov. 14, 2002

(54) Braking system with self-generating effect for adjusting the torque

(76) Inventor: Shui-Jung Chen, Sanchung (TW)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/852,069

(22) Filed: May 10, 2001

(51) Int. Cl. F16D 51/00; B60L 7/00

(52) U.S. Cl. 188/74; 188/158

(57) ABSTRACT

The present invention relates to a braking system with self-generating effect for adjusting the torque having a cast or wrought iron rotor rotating along with the main shaft and a stator with at least two sets of curved brake shoes. A plurality of permanent magnets with poles being alternatively north and south are annularly provided around the inside rim of the cast or wrought iron rotor. When the rotor rotates, an induction between the permanent magnets and the curved brake shoes occurs to cause an eddy current brake effect to the rotating rotor. In addition, one or several generating coils are disposed on the stator. When the rotor rotates, an induction between the permanent magnets and the generating coils occurs. Therefore, an AC electromotive force is induced and converted into DC current by means of a rectifier and a voltage stabilizer for the use of the drive mechanism to adjust the braking force and for the use of the console.

### BACKGROUND OF THE INVENTION

1. Field of the Invention

The present invention relates to a braking system with self-generating effect for adjusting the torque, more particularly, to a braking system with induced currents for the use of the drive mechanism to adjust the braking force and for the use of the console.

2. Description of the Prior Art

Generally, the conventional braking system for exercise bikes primarily includes a cast iron rotor 01 and a stator 02 (see FIG. 5). At least two curved brake shoes 03 are pivotably mounted on the stator 02 while each of the curved brake shoes 03 is fitted with one or two arched permanent magnets 04 facing the inside rim of the cast iron rotor 01. A proper clearance is kept therebetween. When the cast iron rotor 01 rotates, an eddy current produced between the permanent magnets 04 and the cast iron rotor 01 is used to retard the rotational motion of the cast iron rotor 01. Moreover, the greater the clearance between the permanent magnets 04 and the cast iron rotor 01 is, the greater the eddy current and the braking force is. Thus, a pull cable 05 is provided for manually controlling the clearance between the inside rim of the cast iron rotor 01 and the permanent magnets 04 of the curved brake shoes 03 so that the braking torque is adjustable.

In order to reach an electric control of the braking torque, a power source has to be supplied to an electric drive mechanism. However, it leads to troubles in wiring.

### SUMMARY OF THE INVENTION

It is therefore a primary object of the present invention to eliminate the above-mentioned drawbacks and to provide a braking system with self-generating effect for adjusting the torque wherein a plurality of permanent magnets with poles being alternatively north and south are annularly provided around the inside rim of the cast or wrought iron rotor. When the rotor rotates, an induction between the permanent magnets and the curved brake shoes occurs to cause an eddy current brake effect to the rotating rotor. In addition, one or several generating coils are disposed on the stator. When the rotor rotates, an induction between the permanent magnets and the generating coils occurs. Therefore, an AC electromotive force is induced and converted into DC current by means of a rectifier and a voltage stabilizer for the use of the drive mechanism to adjust the braking force and for the use of the console.

### BRIEF DESCRIPTION OF THE DRAWINGS

The accomplishment of the above-mentioned object of the present invention will become apparent from the following description and its accompanying drawings which disclose illustrative embodiments of the present invention, and are as follows:

FIG. 1 is a plan view of a first embodiment of the present invention after assembly;

FIG. 2 is a local view of the structure of the self-induced current of the present invention;

FIG. 3 is a circuit diagram of the self-excited electricity generation of the present invention;

FIG. 4 is a plan view of a second embodiment of the present invention after assembly; and

FIG. 5 is a plan view of a prior art braking system after assembly.

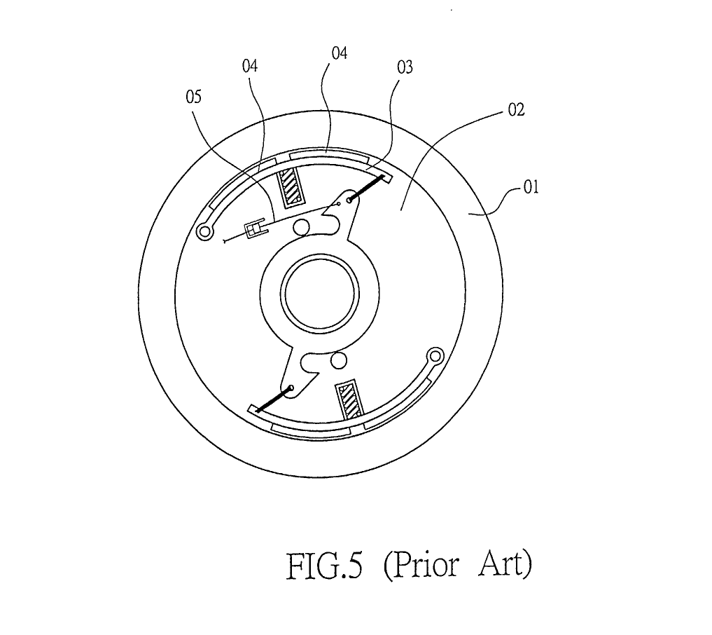

### DETAILED DESCRIPTION OF THE PREFERRED EMBODIMENT

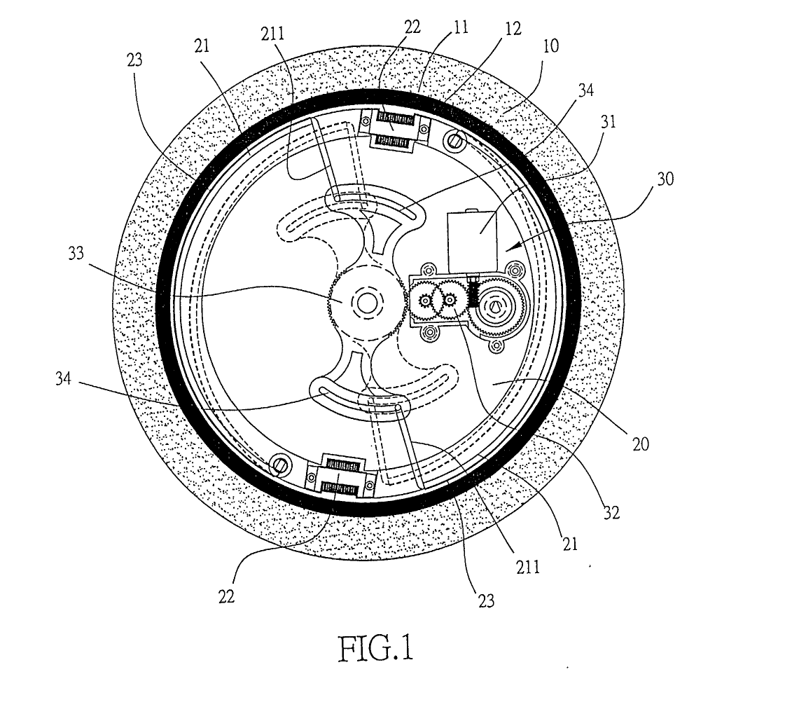

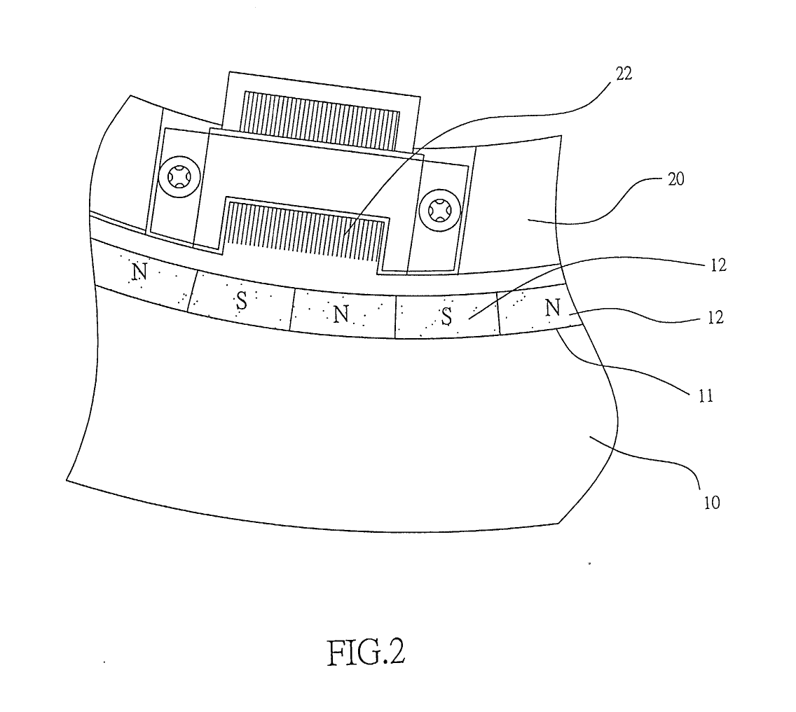

First of all, referring to FIGS. 1 and 2, the braking system with self-generating effect for adjusting the torque in accordance with the present invention primarily includes a cast or wrought iron rotor 10 rotating along with the main shaft and a stator 20 with at least two sets of curved brake shoes 21. One end of each of the curved brake shoes 21 is pivotably mounted on the external surface of the stator 20 while the other end thereof is free. Each curved brake shoe 21 corresponds to the inside rim 11 of the cast or wrought iron rotor 10 in curvature. The clearance between the curved brake shoes 21 and the cast or wrought iron rotor 10 is controllable by a drive mechanism 30.

A plurality of permanent magnets 12 with poles being alternatively north and south are annularly provided around the inside rim 11 of the cast or wrought iron rotor 10. When the rotor rotates, an induction between the permanent magnets and the curved brake shoes occurs to cause an eddy current brake effect to the rotating rotor. In addition, one or several generating coils are disposed on the stator. When the rotor rotates, an induction between the permanent magnets and the generating coils occurs. Therefore, an AC electromotive force is induced and converted into DC current by means of a rectifier and a voltage regulator for the use of the drive mechanism to adjust the braking force and for the use of the console.

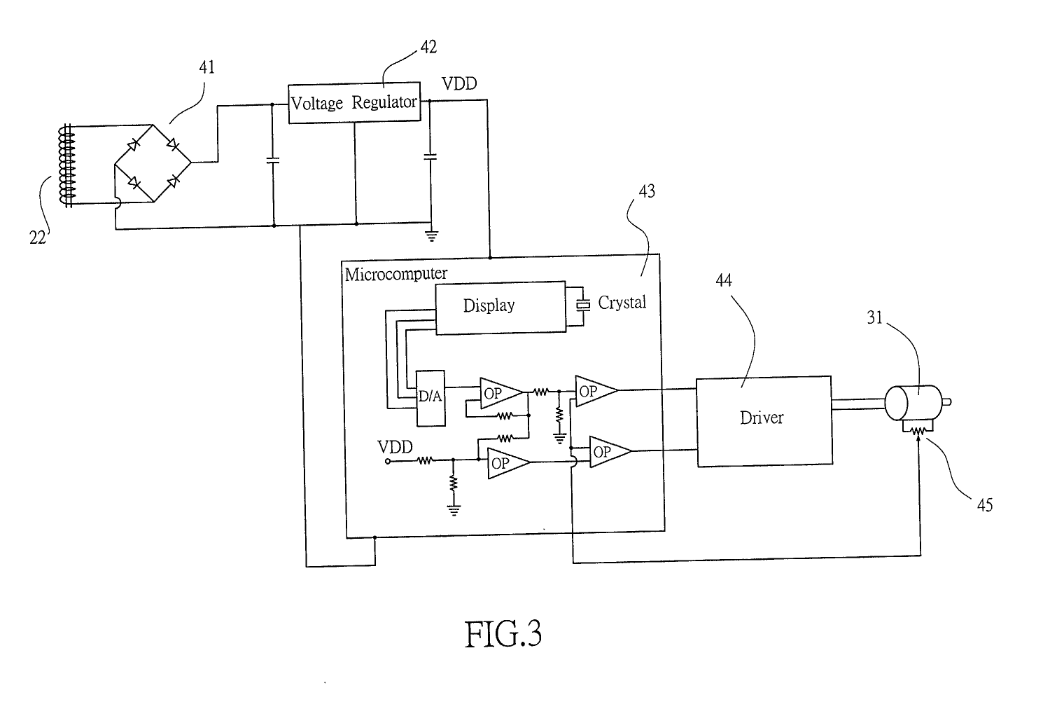

With reference to FIG. 3, when the AC electromotive force is produced by the induction of the permanent magnets 12 and the generating coil 22, it passes through a rectifier 41 and a voltage regulator 42 for the purpose of the DC generation to feed back to the drive mechanism 30 (see FIG. 1). Meanwhile, the DC current is controlled by a microprocessor circuit 43 to drive a minimotor 31 of the drive mechanism 30 in rotation through a drive circuit 44. Thereafter, the free end of each of the curved brake shoes 21 is movable for electrically controlling the clearance between the curved brake shoes 21 and the permanent magnets 12 of the cast or wrought iron rotor 10. In addition, a position sensor 45 is simultaneously actuated to detect the position of the curved brake shoes 21 while the minimotor 31 of the drive mechanism 30 is brought in rotation. In the present invention, the position sensor 45 is formed of a variable resistance.

Again, referring to FIG. 1, the drive mechanism 30 of the present invention includes a minimotor 31, a gear set 32, a circular toothed disk 33 and two extension members with an eccentric curved slot 34, respectively. One end of a pull rod 211 is secured to the free end of each of the curved brake shoes 21 while the other end thereof is hooked into the respective curved slot 34. The circular toothed disk 33 rotates clockwise and counterclockwise through the gear set 32 by means of the drive of the minimotor 31 so that the pull rod 211 is movable in the curved slot 34 for adjusting the clearance between the curved brake shoes 21 and the permanent magnets 12 around the inside rim 11 of the cast or wrought iron rotor 10. Accordingly, the electric control of the braking torque is attainable.

Furthermore, a copper plate (or aluminum plate) 23 is stuck to the surface of the curved brake shoes 21 in order to enhance the retarding effect of the eddy currents to the rotor during the relative movement between the permanent magnets 12 of the cast or wrought iron rotor 10 and the curved brake shoes 21. The generating coil 22, as illustrated in FIG. 2, can be wound around the central part or the support arms at both sides of the upside-down U-core.

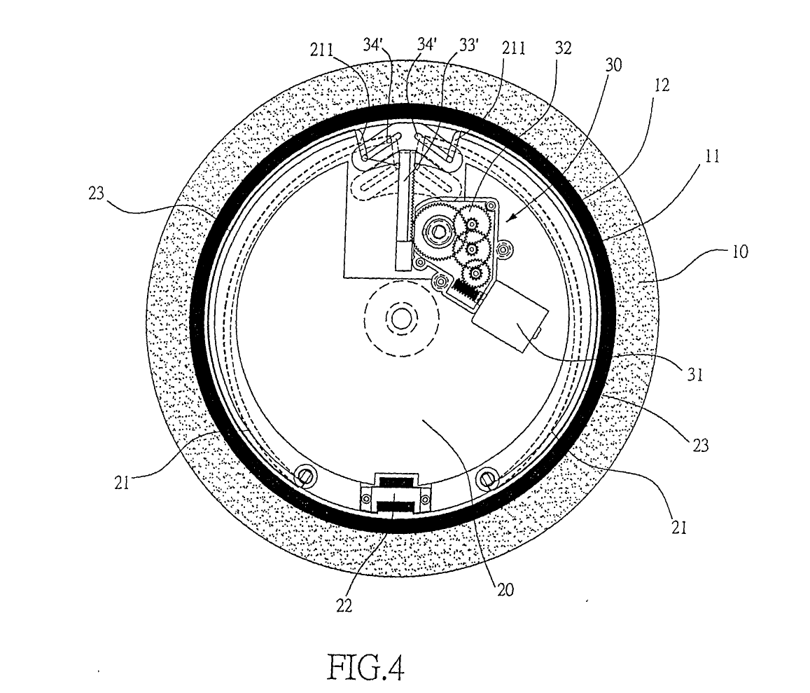

Another embodiment of the present invention, as shown in FIG. 4, includes a minimotor 31, a gear set 32 and an arrow-shaped drive element 33′ engaged with the outermost gear of the gear set 32. Both sides of the arrow tip are fitted with an elongated slot 34′, respectively. One end of a pull rod 211 is secured to the free end of each of the curved brake shoes 21 while the other end thereof is hooked into the respective elongated slot 34′. The gear set 32 rotates clockwise and counterclockwise by the minimotor 31 while an upward and downward linear movement of the arrow-shaped drive element 33′ is driven by the gear set 32. Accordingly, the pull rod 211 is movable in the elongated slot 34′ for adjusting the clearance between the curved brake shoes 21 and the permanent magnets 12 around the inside rim 11 of the cast or wrought iron rotor 10. Accordingly, the electric control of the braking torque is also attainable.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A braking system with self-generating effect for adjusting the torque comprising:
a cast or wrought iron rotor rotating along with the main shaft and
a stator having at least two sets of curved brake shoes, one end of each of said curved brake shoes being pivotably mounted on the external surface of said stator while the other end thereof is free, each said curved brake shoe corresponding to the inside rim of said cast or wrought iron rotor in curvature, the clearance between said curved brake shoes and said cast or wrought iron rotor being controllable by a drive mechanism;
wherein a plurality of permanent magnets with poles being alternatively north and south are annularly provided around the inside rim of said cast or wrought iron rotor; and
when the rotor rotates, an induction between the permanent magnets and the curved brake shoes occurs to cause an eddy current brake effect to the rotating rotor.

2. The braking system with self-generating effect for adjusting the torque as recited in claim 1, wherein one or several generating coils are disposed on said stator; and when the rotor rotates, an induction between the permanent magnets and the generating coils occurs so that an AC electromotive force is induced for the use of said drive mechanism to adjust the braking force and for the use of a console.

3. The braking system with self-generating effect for adjusting the torque as recited in claim 1 or 2, wherein said drive mechanism includes a minimotor, a gear set, a circular toothed disk and two extension members with an eccentric curved slot, respectively; and
one end of a pull rod is secured to the free end of each of said curved brake shoes while the other end thereof is hooked into said respective curved slot; and
said circular toothed disk rotates clockwise and counterclockwise through said gear set by means of the drive of said minimotor so that said pull rod is movable in the curved slot for adjusting the clearance between said curved brake shoes and said permanent magnets around the inside rim of said cast or wrought iron rotor.

4. The braking system with self-generating effect for adjusting the torque as recited in claim 1 or 2, wherein said drive mechanism includes a minimotor, a gear set and an arrow-shaped drive element engaged with the outermost gear of gear set; and
both sides of the arrow tip are fitted with an elongated slot, respectively, and
one end of a pull rod is secured to the free end of each of said curved brake shoes while the other end thereof is hooked into the respective elongated slot, and
said gear set rotates clockwise and counterclockwise by said minimotor while an upward and downward linear movement of said arrow-shaped drive element is driven by said gear set so that said pull rod is movable in the elongated slot for adjusting the clearance between said curved brake shoes and said permanent magnets around the inside rim of said cast or wrought iron rotor.

5. The braking system with self-generating effect for adjusting the torque as recited in claim 3 or 4, wherein a position sensor is simultaneously actuated to detect the position of said curved brake shoes while said minimotor of said drive mechanism is brought in rotation.

6. The braking system with self-generating effect for adjusting the torque as recited in claim 5, wherein said position sensor is formed of a variable resistance.

7. The braking system with self-generating effect for adjusting the torque as recited in claim 1, 2, 3 or 4, wherein a copper plate (or aluminum plate) is stuck to the surface of said curved brake shoes in order to enhance the retarding effect of the eddy current during the relative movement between said curved brake shoes and said permanent magnets of said cast or wrought iron rotor.
